(19) United States
(12) Patent Application Publication
(10) Pub. No.: US 2006/0149669 A1
(43) Pub. Date: Jul. 6, 2006

(54) System, program and method for determining the compensatory value to avoid contract termination over computer network

(76) Inventor: Khai Hee Kwan, Sydney (AU)

Correspondence Address: KHAI HEE KWAN, 315 AVOCA ST., RANDWICK, 02031, AU

(21) Appl. No.: 10/863,180

(22) Filed: Jun. 8, 2004

Related U.S. Application Data
(63) Continuation-in-part of application No. 09/534,233, filed on Mar. 24, 2000.
(63) Continuation-in-part of application No. 10/614,919, filed on Jul. 3, 2003.

(51) Int. Cl. G06Q 40/00

(52) U.S. Cl. 705/39; 705/42

(57) ABSTRACT

A computer program, system and method for determining compensatory amount in a deposit-share exchange agreement over a computer network such as the Internet. Such compensatory amount is necessary to accord and satisfaction in place of an action to sue by depositor for damages where the deposit institution failed to exchange its obligation with said depositor. This compensatory amount is also an inducement to keep deposit agreement on foot. The computer system includes a computer connected to the Internet, which performs the following functions: (1) receiving details from a prospective depositor over a network; (2) and receive the compensatory amount as calculated by deposit institution.

### CROSS-REFERENCE TO RELATED APPLICATIONS

This application is Continuation-In-Part to U.S. patent application Ser. No. 09/534233 filed on Mar. 24, 2000 and U.S. patent application Ser. No. 10/614919 filed on Jul. 3, 2003, both said applications herein incorporated by reference.

### STATEMENT REGARDING FEDERALLY SPONSORED RESEARCH OF DEVELOPMENT

Not Applicable.

### REFERENCE TO A MICROFICHE APPENDIX

Not Applicable.

### FIELD OF THE INVENTION

The present invention is a continuation-in-part to our previous application Ser. No. 09/534233 for conducting an electronic financial asset deposit auction such that a prospective depositor may choose among financial bids such as borrowing rate and non-financial bids the one that offers the most favourable terms and return potential. More particularly, the present invention relates to determining a penal or punitive or compensatory amount in the event where said terms accepted by depositor and deposit institution were unable to be fulfilled by both or one party. Whether it is a penalty or punitive or compensatory is dependent on the question of who is the disabling party.

For example if the term of deposit provides for an exchange of financial asset but in the event of NO exchange what is the appropriate mechanism to compensate the depositor for the lost opportunity and similarly the penalty for the institution? The following will detail the method use to determine the solution.

### BACKGROUND OF THE INVENTION

Traditionally, a person in need to find the highest return for his financial asset such as cash or shares will be faced with a number of difficult choices where he/she is faced with many offerings being maintained in accordance to a fix number of pre-determined criteria. He/she is asked to search a number of banking/deposit institution sites in order to find the best rates/offerings.

Our U.S. patent application Ser. No. 09-534233 describes various means of submitting anonymously to various depositing institutions to solicit their bids as a way to achieve a higher rate. Said application includes bid terms by responding institution whereby financial assets are exchange in part or in whole with the deposits.

This invention relates to U.S. patent application Ser. No. 09-534233 whereby said provide bids which terms of exchange should also be complemented with an opportunity to revoke such term of exchange after being agreed by both depositor and deposit institution but without voiding the contract. This is to say given the volatility of the overall investment market and where the deposit institution wish to revoke such exchange terms, how could this be done fairly to both parties so to ensure such depositing agreement is still on foot. The solution is to provide an indicative or approximate compensatory value or penalty amount for revoking such term as part of the bid in acknowledgement that should the contracted exchange failed, then this compensatory amount would be paid to the depositor. This is to say from the deposit institution is a penalty for breach of deposit contract wherein the essential or root term is one of exchanging the deposit for financial assets. The current solution is to bring this issue to court and as per any breach of contract, the depositor may sue for damages. We believe this is unsatisfactory and may harm the possibility of furthering the exchange mechanism as part of the offering in our application in Ser. No. 09-534233. By defining the appropriate penalty or compensatory amount in the event of a failure, the depositor is bound or compel to complete the contract and there is no excuse to terminate the contract since the default provision is provided. Alternatively, in common law for an agreement not to sue upon particular allegation, it is also necessary to show that any compensatory amount is in an accord and satisfaction discharging the cause of action or else it gave rise to an estoppel. Therefore, the essence of accord and satisfaction is the acceptance by the plaintiff of something in place of his cause of action. In this invention this is the compensatory amount being paid on failure to perform. Obviously the depositor could still seek the indulgence of the court in the event where the promised penalty or compensatory is not forthcoming and this invention is by no means limiting that avenue. This invention is designed to cure an apparent issue dealing with potential or anticipated breaches of depositing contracts which could be caused by either defaulting events by the depositor or institution triggered by volatile investment market. The current method dealing with the common breach of early withdrawal by depositor is simply to withhold the interest payable or to pay pro-rata. However, this approach may not be useful for complex depositing agreements that includes exchange for financial assets or swaps given the complexity of deriving the actual opportunities costs and dependent on who is at fault. There is also a possibility of unwinding cost for the financial positions entered by the institution but such cost may not be known at the outset of the deposit agreement. As mentioned this term of compensation or breach or penalty is preferably calculated or approximated prior to entering into a deposit agreement or form part of the bid term to ensure that both parties are locked in by the contract.

Other possibilities includes breaches by the depositors whereby they withdraw the deposit such as financial assets to be exchange for cash (converse of the above situation where they offer deposits for exchange with financial assets) Or where depositor withdraw their deposit (cash) before the end of the contracted deposit period.

Obviously having defined the problem, then an appropriate determination method is required which is detailed in this invention. In general but not limiting, we have applied option pricing formula well known in the art such as Black Scholes or Binomial pricing models to calculate such compensatory amount by treating it as a premium for a put. While such models are well known in the art there is no teaching of combining the application as a basis for compensating a depositor for missed or failed opportunity to exchange said deposit for the underlying financial asset. Financial assets here would be any instruments such as gold, silver, treasury, shares, bonds etc which are well known to one skilled in the art of investment.

It is therefore an object of the present invention to provide a system for including a method to determine compensatory amount in the event there is no exchange for the underlying financial security.

It is a further object of the present invention that such compensatory amount be calculated and provided for the depositor as an approximation as part of a bid in deposit auction conducted by using a computer network or networks, such as the Internet. However, there is nothing to prevent such calculative means to be separated from an auction process and could be queried on demand by a potential depositor over a network.

### SUMMARY OF THE INVENTION

The present invention provides program, system and method for determining a compensatory amount to be paid in the event a promised exchange failed and to provide such rate or amount to the potential depositor as part of the bid or on request.

The Inventor has developed a method of utilising a telecommunications service system host computer connecting to various terminal system including Automatic Teller Machines (ATM) or wireless devices which is linked to private networks or a public telephony system network or through the Internet where applicable. The system consists at least a network of computer system with a multi-communication interface running on Windows 2000 or Unix or Linux platform with programming using Java, Visual Basic, C plus plus language or any suitable programming language. A database such as MS SQL or Oracle is used to store, record and updates all the contracts and transactions.

Thus in brief, according to one embodiment of the invention there is provided,
a process system comprising:
receiving an incoming request from a terminal through the public telephony system network via a modem or through the Internet or any connecting interface suitable for this purpose;
the said request comprises the details of the deposit amount, the term of exchange to include the price or the quantity of the financial asset to be exchanged and the type of financial asset and the time period of the deposit.
upon receiving the details calculating the compensatory rate or penalty cost if the exchange did not take place within the time period.

In accordance with the present invention, a system for conducting an electronic financial asset depositing auction wherein incorporate a means to calculate the compensatory rate comprises a client computer, a host computer and at least one computer network connected to said computers. The program for determination of this compensatory amount could be programmed into the computer connected to the deposit institution or within the host computer which is triggered upon detecting a bid that includes a term for exchange of financial asset.

In another embodiment, the host computer is a computer server for a single deposit institution and the computer network is the Internet. This computer is linked to a depositor's computer whereby the potential depositor could submit details of his or her depositing requirements such as amount, period and the price and type of financial asset to be exchange. This is a singular embodiment without the auctioning process whereby the compensatory could be calculated on demand or pre-calculated for listing alone with general exchange conditions ready for selection by depositor/user.

Upon submitting said details, the server would calculate the compensatory amount to be paid in the event that a potential exchange is not successful or revoked by the depositing institution. Preferably, the server in this embodiment is one referencing to a deposit institution and has a database consisting the available financial assets to be exchanged and their properties such as standard deviation of price, quantity of financial assets and availability coincidental to the maturity at the end of time period for deposit. It is preferably that this server is connected to a real time connection to determine the real time value of said financial asset and able to access the real time cost of funds. These connections to various markets are well known in the art. As mentioned, if an option formula is used then the necessary variables are required such as free rate cost, standard deviation of the underlying financial asset price, current price of said asset, the price to be exchange and time period and obviously the identification of the financial asset such as Share, IBM, NYSE. Alternatively, one can also derived the quantity of financial asset to be exchanged rather than using the price to be exchanged as found in the option formula. Ie depositor inputting say 100 IBM shares rather than IBM at 56.00 as required in an option formula known in the art such as Black Scholes.

Preferably a rate of return should also be calculated to improve the understanding for the potential depositor.

In another embodiment, the host computer is a computer server, and the computer network is the Internet. The server computer is connected, via the Internet, to a plurality of depositors' computers and a plurality of depositing institutions' computers. Alternatively, more than one computer network may be used in the system of the present invention. For example, one computer network, such as the Internet, is used to connect the depositors' computer to the server computer; a proprietary computer network is used to connect the deposit institutions' computers to the server.

During the financial asset depositing auction process whereby a responsive bid is submitted whereby it is an exchange term, such bid will include the compensatory amount as determined by the deposit institution's computer networked to the host server. The detailed workings of the deposit auction is found in our application U.S. patent service Ser. No. 09/534233 filed on Mar. 24, 2000 which is incorporated by reference.

As mentioned the novelty in the present invention provides a convenient way for institution to revoke with penalty a deposit arrangement particularly one including an exchange term for financial asset without voiding the contract. This 5 accommodating feature would solve the negative issue in having to voiding a contract on the count of performance failure which may result in litigation.

While we prefer a more mathematically approach such as applying an option model to calculate the compensation for depositor, one skilled can readily fix say at seven percent on top of the prevailing interest rate. This alternative approach could simply be linked to a compensatory market rate prevailing amongst the various deposit institutions. Say Deposit Institution A provided a compensatory bid of 5% then Deposit Institution B may wish to better this at 5.5% or Deposit Institution C may have policies not permitting it to provide more than 3% for amount up to $100,000. In another embodiment, the rate is calculated based on certain heuristic rules and are provided in response to other rates competitively or even based on depositors' history or dealings with the institution. One skilled in the art of customer behaviour or marketing could easily design rules that are market orientated geared to retain loyalty. Noting that this is a penalty for the deposit institution, hence a failure to exchange or perform other obligation within the deposit agreement for a valuable client should be compensated higher than for a normal client.

It is also obvious one skilled in the art could also adapt the teaching here into other situation wherein a depositing agreement is involved, such as in a deposit for a future purchase of a motor vehicle, boat, plane or house or building or any real property where to avoid potential breaches as long as the current price, free interest cost, standard deviation of underlying asset's prices, the purchase price, period to purchase are known as per variables found in an option model.

The foregoing has outlined some of the more pertinent objects and features of the present invention. These objects should be construed to be merely illustrative of some of the more prominent features and applications of the invention. Many other beneficial results can be attained by applying the disclosed invention in a different manner or modifying the invention as will be described. Accordingly, other objects and a fuller understanding of the invention may be had by referring to the following.

### BRIEF DESCRIPTION OF THE DRAWINGS

FIG. 1 is a simplified block diagram of a client-server environment in which the present invention may be implemented;

FIG. 2 is a block diagram of a preferred central controller;

FIG. 3 is a block diagram of a preferred client terminal;

FIG. 4 is a representative user screen for determining the compensatory cost.

### DETAILED DESCRIPTION OF THE INVENTION

This invention provides a program, system and method for calculating the compensatory amount in the event there is a failure for financial asset exchange in a deposit agreement. In accordance with our previous application U.S. patent application Ser. No. 09-534233, a prospective depositor, is more likely to discover a suitable match at more realistic terms and effectively than those he/she would have obtained by traditional ways. For example, there are individuals who prefer higher risk than available from standard banking depositing facilities would be able to seek to exchange the deposit for shares or other financial assets.

Accordingly in our previous invention, the bidder may define proposed terms of deposit in the bid application under various combinations such as period of deposit, type of deposit, type of payment schedule, deposit rate, securities in exchange and terms of exchange. A responsive bidder will bid by either matching these terms or better them to existing bids by other bidders.

In this invention, we are concerned about the commitments from the deposit institution in the event when such exchange failed and to provide a way to compensate such failure satisfactory to both depositor and institution at the outset and incorporate this as part of the depositing bid terms. For example, the institution could fail to procure the underlying securities from the open market to be exchanged with depositor due to market volatility. Therefore it is useful to be certain of the compensatory or penalty rate to be paid in the event the exchange failed. The compensatory amount is designed and will only be paid to avoid any termination of the deposit contract arising from anticipatory breach of contact by asserted.

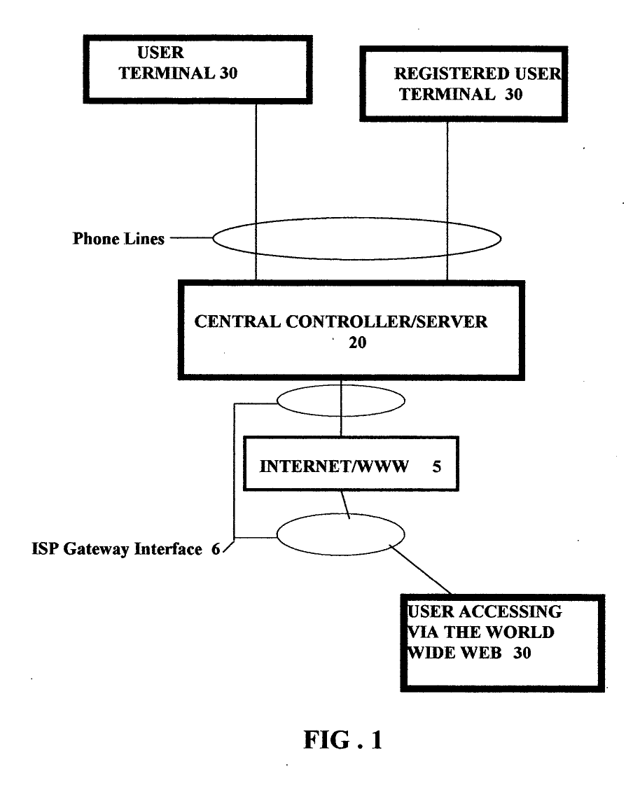

A representative system in which the present invention is implemented is illustrated in FIG. 1. A plurality of Internet client machines or terminals 30 are connectable to a computer network Internet Service Provider (ISP) 6 via a network such as a dialup telephone network. ISP 6 interfaces the client machines or terminals 30 to the remainder of the network 5, which includes a plurality of web content server machines or central controller 20. Network 5 (such as the Internet) typically includes other servers for control of domain name resolution, routing and other control functions. A client machine typically includes a suite of known Internet tools, including a Web browser, to access the servers of the network and thus obtain certain services. These services include one-to-one messaging (e-mail), one-to-many messaging (bulletin board), on-line chat, file transfer and browsing. Various known Internet protocols are used for these services. Thus, for example, browsing is effected using the Hypertext Transfer Protocol (HTTP), which provides users access to multimedia files using Hypertext Markup Language (HTML). The collection of servers that use HTTP comprise the World Wide Web, which is the Internet's multimedia information retrieval system.

As will be seen, a given server in the computer network operates a web site at which a plurality of depositor may solicit a depositing term by providing their depositing details which includes a desired to exchange for financial assets. A given client machine and the server may communicate over the public Internet, an intranet, or any other computer network. If desired, given communications may take place over a secure connection. Thus, for example, a client may communicate with the server using a network security protocol, such as Netscape's Secure Socket Layer (SSL) protocol or the IETF's Transport Layer Security (TLS) protocol.

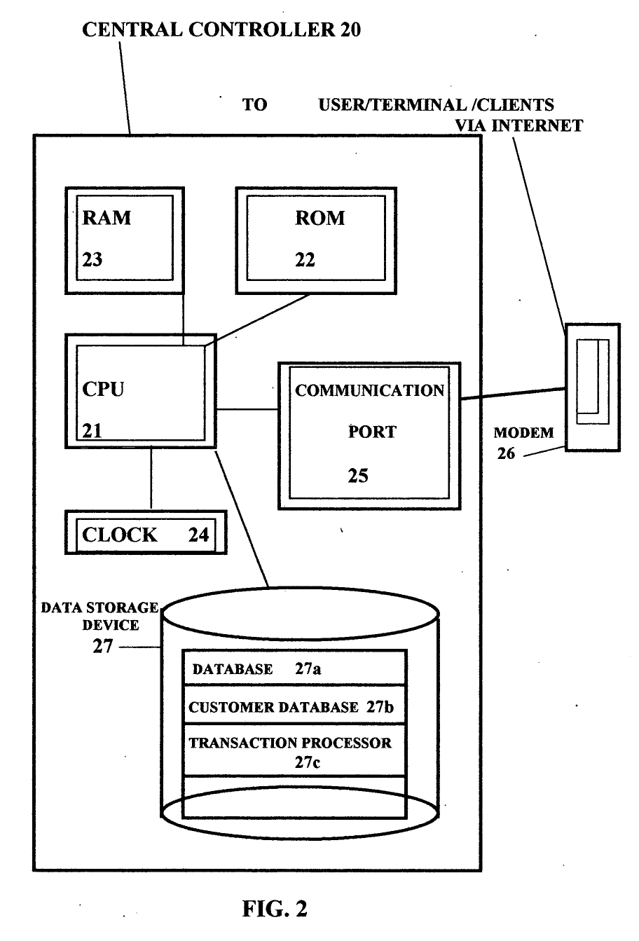

FIG. 2 is a block diagram of a preferred server machine or central controller 20. The central controller includes a CPU 21 which performs the processing functions of the controller. It is also includes a read only memory 22 (ROM) and a random access memory 23 (RAM). The ROM 22 is used to store at least some of the program instructions that are executed by the CPU 21 such as portions of the operating system or BIOS or a program and the RAM 23 is used for temporary storage of data. A clock circuit 24 provides a clock signal which is required by the CPU 21. The use of a CPU 21 in conjunction with ROM and RAM and a clock circuit is accepted to those skilled in the design of the CPU based electronic circuit design. The central controller 20 also includes a communication port 25 which enables the CPU 21 to communicate with devices external to the central controller 20. In particular the communication port 25 facilitates communication between the modem 26 and the CPU 21, so that information arriving from the modem 26 can be processed by the CPU 21 and the CPU 21 can send information to remote location via the modem 26.

While the illustrated embodiment uses a modem for communicating with devices outside the central controller, it should be understood readily that other methods of communicating with external devices may be used instead of the modem. These other methods include hard-wired connections, wireless such as radio frequencies, fibre optic lines, network card etc.

The CPU 21 can also store information to and read information from, the data storage device 27. This data storage device 27 includes a transaction database 27a and a customer database 27b. In addition, it includes transaction processor instruction 27c which can be read by and executed by the CPU 21, thereby enabling the CPU 21 to process transactions. While FIG. 2 depicts separate transaction and customer databases, a single database that incorporates both of those functions may be used.

A representative web server is an IBM Netfinity server comprising a RISC-based processor, a UNIX-based operating system and a web server program. The server may include an application programming interface (API) that provides extensions to enable application developers to extend and/or customize the core functionality thereof through software programs including plug-ins, CGI programs, servlets, applets and the like.

The present invention is preferably implemented as a computer program operative at a web server. Although the invention will be described in the context of a single web server, one of ordinary skill in the art will appreciate that the described functionality may be implemented across multiple servers.

Moreover, the web site may be mirrored at additional servers in the network and, if desired, one or more management servers or other computer resources may be used to facilitate various billing, accounting and administrative functions as a “back end” to the underlying site.

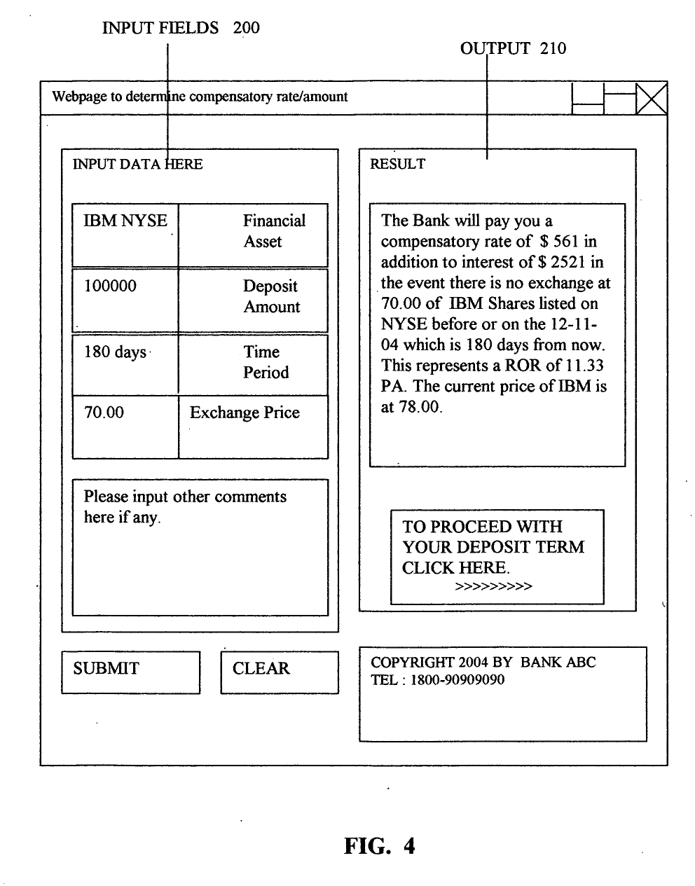

The computer program at the web site includes appropriate display routines for generating a set of display screens that together comprise a user interface for the site. FIGS. 4 is a representative display screen, although the particular screen layouts should not be taken to limit the scope of the present invention. One skilled in the art will be able to program routine to enable such representations including various sub-routine to calculate Internal Rate of Return (IRR).

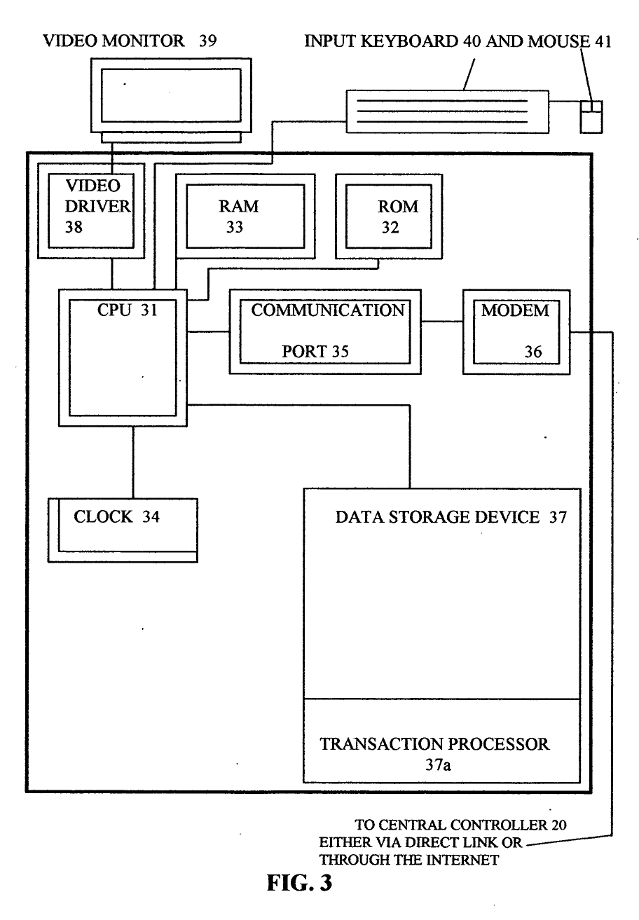

FIG. 3 is a block diagram of a preferred client terminal normally used by the potential depositor. As discussed there can be a number of client terminals 30 linked to the one or more server or central controller 20. Like the central controller described above, the terminal 30 includes a CPU 31, ROM 32, RAM 33 and a clock circuit 34. The terminal 30 also includes a communication port which interfaces with a modem 36 that facilitates communication between the client terminal 10 and the central controller 20. Of course instead of a modem 36 other communication devices can be used as shown above for the central controller 20.

The client terminal 30 also includes an input device 40 to receive input from an operator or user. Any of a wide variety of input devices would be suitable including touch screen, mouse 41, keyboard 40. The input device 40 may interface directly with the CPU 31 as shown in the figure. Alternatively an appropriate interface circuit may be placed between the CPU 31 and the input device 40.

The client terminal 30 also includes a video monitor 39 for conveying information to the operator. While the most preferred video monitor 39 is a CRT, other video display devices including LCD, LED and thin film transistor panels, may be used as well. A video driver 38 interfaces the CPU 31 to the video monitor 39 (or to any other type of video display device). The terminal 30 also includes a data storage device 37 in which transaction processor instructions 37a are stored. These instructions can be read by and executed by the CPU 31 thereby enabling the CPU 31 to process transactions. Typically the client terminal 30 will run a browser type of software which enables it to access information via the Internet 5 and onwards to the central controller 20.

A client terminal 30 is a personal computer, notebook computer, Internet appliance or pervasive computing device (e.g., a PDA or palm computer) that is PowerPC.RTM.- or RISC-based. The client includes an operating system such as Microsoft Windows, Microsoft Windows CE or PalmOS. As noted above, the client includes a suite of Internet tools including a Web browser, such as Netscape Navigator or Microsoft Internet Explorer, that has a Java Virtual Machine (JVM) and support for application plug-ins or helper applications. A standard computer such as an IBM PC, Apple Macintosh, running appropriate custom designed software may be used as the terminal.

Having discussed the hardware embodiments, we can proceed to the steps to committing to a compensatory pricing program.

FIG. 4 is a web page being accessed by a depositor using terminal 30. The required steps of satisfying the inputs/outputs shown in FIG. 4 may be implemented in a computer program that may be installed at the terminal or remotely on the central controller 20. For example a computer readable medium (such as a floppy disks or CD-ROMs) which is then stored in memory, in this case the data storage device 37 (Shown in FIG. 3). Alternatively, although not so describe below, the computer program be installed at the central controller 20 from a computer readable medium and then stored therein in one or more of the ROM memory 22, RAM memory 23 and data storage device 27 for access and use by terminals 30 as required.

Proceeding to FIG. 4, the process starts when a depositor contacts the deposit institution's website and input the fields as in 200. Alternatively, a registered user can access it through the ISP Gateway 6 by using browser programs which connects to the central controller 20. Where possible mirror sites are available for faster access. The web page provides a menu to input data information in 200. This information comprises for example: financial asset, exchange price or quantity (not shown here), deposit amount and period such as start date and ending date. Other information known by one skilled in the art may be inputted at this stage as long as they are provided in order for the central controller to make a proper analysis. The information is entered by depositor into terminal 30. The said information are then transmitted to the central controller 20 in FIG. 2 and process with the result transmitted to terminal 30.

Returning to FIG. 3, each of the data fields 200 as described above in FIG. 4 are executed by the CPU 31 which is executing transaction processor instructions 37a stored in data storage device 37 which are loaded on to memory 32 for execution. The communication with the central controller 20 takes place via the communication port 35 and modem 36 or as the case may be, with Internet 5 through ISP Gateway Interface 6.

The information (and optional customer data) from the terminal 30 is received by the central controller 20. As the case maybe, the calculation of the compensatory rate may be determined by either using the Black Scholes option model (as the case in FIG. 4 in output 210) or multiplying the result of the modified Black Scholes by other factors. The modified Black Scholes being used here is also known as the base value.

The other factors which are also known as the adjusting factors are calculated based on heuristic rules unique to the user's requirements. Such rules are stored in the database or maybe embedded in the main program which are called when required. Appropriate call functions can be used to pronounce these rules. It is preferred that these rules are updateable remotely by the institution concerned on a real time basis. For example, the failure factor (unable to complete the exchange) may be currently standing at 1.20. These factors are build from past demand information and are subject to changes.

For example, to retain clients' loyalty through no fault of their own, a higher factor can be added.

The variables or adjusting factors used can be continuously or discretely variable. One set of discretely varied variables is described in the table below. There are according to this invention many ways of calculating the value and as such these methods are only for demonstration purposes.

L A factor related to the expected failure for a type of financial asset to be exchanged. In this example, L increases as the expected failure increases.

| | |
|---|---|
| High Failure | 1.2 |
| Medium | 1.0 |
| Low Failure | 0.7 |

Z A factor related to the demand for type of financial asset as

| | |
|---|---|
| Above 100,000 | 1.6 |
| Between 50,000-99,000 | 0.9 |
| Below 49,999 | 0.8 |

C A factor related to retaining the depositor for future business

| | |
|---|---|
| Customer has been with us for 5 years or more | 1.1 |
| Customer has been with us for 5 years or less | 0.8 |

Using these variables, a suitable algorithm for calculating an appropriate adjusted compensatory value or financial value is as follows:
Compensatory value=B*Z*L*C
or
Financial value=B*Z*L*C

B represents a base value that can be calculated from a modified Black Scholes or similar type of option formula.

It should be mentioned that conditions and changes may be made to the above formula from time to time to reflect changes in the environment. For example if over time the option formula which formulate the base value is sufficient to reflect the compensatory value then we would ignore Z, C, L (adjusting values). On the other hand, more variables such as residual value or interest cost risk or pricing risk levels may be included subject to further studies.

The above is only an example for demonstration purposely. More sophisticated formula may be used. Once the penalty/compensatory/financial amount has been calculated as shown above, it is transmitted to the customer in field output 210. After the result of the calculated penalty rate is transmitted to the customer as seen in 210 at terminal 30, the customer decides whether to accept the contract or reject or clear data or re-enter new data again.

Having thus described our invention, what we claim as new and desire to secure by Letters Patent is set forth in the following claims. While the present invention has been described above in terms of specific embodiments, it is to be understood that the invention is not limited to the disclosed embodiments. On the contrary, the present invention is intended for various modifications and equivalent structures included within the spirit and scope of the appended claims.

1. A method for providing a depositor with a compensatory value comprising the steps of:
tendering an amount for deposit and time period to depositing institution by depositor;
tendering a price or quantity to exchange deposit for financial asset to deposit institution by depositor;
calculating a compensatory value to be compensated to said depositor if deposit is not exchange for financial asset by deposit institution; and
whereby said compensation compels the depositor to accord and satisfaction or not voiding the deposit contract.

2. The method of claim 1 wherein calculating compensatory value is by applying an option formula.

3. The method of claim 1 further comprising an auction process over a network.

4. The method of claim 1 wherein depositor is anonymous.

5. The method of claim 1 wherein calculating compensatory value is based at least in part on the formula below:
Compensatory value=B*Z*L*C
Whereby B is the base value, Z is related to the demand for type of financial asset, L is a factor related to the expected failure for a type of financial asset to be exchanged, C is a factor related to retaining the depositor for future business.

6. An apparatus for providing a depositor with a compensatory value, comprising:
a programmed computer, further comprising:
a memory having at least one region for storing executable program code; and
a processor for executing the program code stored in the memory, wherein the program code implementing method of claim 1.

7. An apparatus for providing a depositor with a compensatory value, comprising:
a programmed computer, further comprising:
a memory having at least one region for storing executable program code; and
a processor for executing the program code stored in the memory, wherein the program code implementing method of claim 2.

8. An apparatus for providing a depositor with a compensatory value, comprising:
a programmed computer, further comprising:
a memory having at least one region for storing executable program code; and
a processor for executing the program code stored in the memory, wherein the program code implementing method of claim 3.

9. An apparatus for providing a depositor with a compensatory value, comprising:
a programmed computer, further comprising:
a memory having at least one region for storing executable program code; and
a processor for executing the program code stored in the memory, wherein the program code implementing method of claim 4.

10. An apparatus for providing a depositor with a compensatory value, comprising:
a programmed computer, further comprising:
a memory having at least one region for storing executable program code; and
a processor for executing the program code stored in the memory, wherein the program code implementing method of claim 5.

11. Computer executable software code stored on a computer readable medium, the code for providing a depositor with a compensatory value comprising:
code for tendering an amount for deposit and time period to depositing institution by depositor;
code for tendering a price or quantity to exchange deposit for financial asset to deposit institution by depositor;
code for calculating a compensatory value to be compensated to said depositor if deposit is not exchange for financial asset by deposit institution; and
whereby said compensation compels the depositor to accord and satisfaction or not voiding the deposit contract.

12. The computer executable software code according to claim 11, further comprising code for calculating a compensatory value by applying an option formula.

13. The computer executable software code according to claim 11, further comprising code for tendering by an auction process.

14. The computer executable software code according to claim 11, further comprising code for anonymising a depositor.

15. The computer executable software code according to claim 11, further comprising code for depositor anonymity.

16. The computer executable software code according to claim 11, wherein code for calculating compensatory value is based at least in part on the formula below:
Compensatory value=B*Z*L*C
Whereby B is the base value, Z is related to the demand for type of financial asset, L is a factor related to the expected failure for a type of financial asset to be exchanged, C is a factor related to retaining the depositor for future business.

17. Computer executable software code stored on a computer readable medium, the code for providing a depositor with a compensatory value comprising:
a programmed computer, further comprising:
a memory having at least one region for storing executable program code; and
a processor for executing the program code stored in the memory, wherein the program code, further comprising:
code for tendering an amount for deposit and time period to depositing institution by depositor;
code for tendering a price to exchange deposit for financial asset to deposit institution by depositor;
code for calculating an approximate financial value to be compensated to said depositor if deposit is not exchange for financial asset;
code for calculating the rate of return for said deposit if there is no exchange;
code of receiving an acceptance or rejection request from depositor for the said exchange request; and
whereby the exchange is avoidable by the depositing institution at any time within the said time period.

18. The computer executable software code according to claim 17, wherein code for calculating a financial value by applying an option formula.

19. The computer executable software code according to claim 17, further comprising code for tendering by an auction process.

20. The computer executable software code according to claim 17, wherein code for calculating financial value is based at least in part on the formula below:
Financial value=B*Z*L*C
Whereby B is the base value, Z is related to the demand for type of financial asset, L is a factor related to the expected failure for a type of financial asset to be exchanged, C is a factor related to retaining the depositor for future business.
